(19) United States
(12) Patent Application Publication
(10) Pub. No.: US 2022/0361465 A1
(43) Pub. Date: Nov. 17, 2022

(54) Double Jig Hook

(71) Applicant: Nuridin Muhammad, Baton Rouge, LA (US)

(72) Inventor: Nuridin Muhammad, Baton Rouge, LA (US)

(21) Appl. No.: 17/572,726

(22) Filed: Jan. 11, 2022

Related U.S. Application Data
(60) Provisional application No. 63/188,650, filed on May 14, 2021.

(51) Int. Cl. A01K 83/00

(52) U.S. Cl. CPC A01K 83/00

(57) ABSTRACT

The present invention relates to a double jig hook that features linear shank(s), two barbed bends, an eyelet, and a jig head. The two bends are positioned at one end of the hook for catching the top and bottom parts of a fish's lip to maximize securement and success rates when hooking fish. The bends includes barbs at their terminal ends and extend in opposing directions. Further, at the other end of the hook, an eyelet is connected at an angle of 90, 45, or 30 degrees relative to the shank(s) wherein the other end of the hook also includes the jig head for attaching a lure or jig thereto. The hook or jig can be made from a single barbed wire or can be made using two wires that are connected to form a pair of shank portions and a pair of bend portions.

### CROSS-REFERENCE TO RELATED APPLICATION

The present application claims priority to, and the benefit of, U.S. Provisional Application No. 63/188,650, which was filed on May 14, 2021 and is incorporated herein by reference in its entirety.

### FIELD OF THE INVENTION

The present invention relates generally to the field of fishing jigs. More specifically, the present invention relates to an improved fishing jig that provides two hooks at the end of a shank for catching the top and bottom parts of a fish's lip to maximize securement and successful chances when catching a fish. Further, at the other end of the shank, an eyelet can be connected at an angle of 90, 45, or 30 degrees to the shank. The hook or jig can be made or bent from a single or dual barbed wire, or can be made using two wires that are intertwined to form the shank portion. The jig can feature a barb at the top of each hook to firmly secure artificial bait to the jig and offers a way to catch more fish and improve the overall enjoyment of a fishing trip. Accordingly, the present disclosure makes specific reference thereto. Nonetheless, it is to be appreciated that aspects of the present invention are also equally applicable to other like applications, devices, and methods of manufacture.

### BACKGROUND

By way of background, jigs and hooks are popularly used artificial lures for fishing a variety of fish species. Many veteran and professional anglers consider jigs superior to other artificial lures due to their versatility and ease of use. Generally, a jig comprises a hook partially embedded within a jig body, and can be often covered by a soft body to imitate the coloring and appearance of baitfish. Standard jigs and hooks may be somewhat effective at catching fish, however some bait may not mimic live bait when threaded on the hook, and thereby fail to lure and catch any fish.

Additionally, with the traditional structure of jigs, people may find it difficult to properly thread the hook onto certain baits and may look for better alternatives. Without proper threading of the hook onto the bait, the fishing may be ineffective, as the bait can easily leave the jig hook while fishing. With the standard jigs heretofore known, fish can be harder to catch and can waste a lot of time of the users.

Furthermore, standard jigs feature one hook that is easily broken and once the hook detaches the jig structure, the complete jig becomes useless, with no means for catching fish. Also, the single hook-based jigs are quite ineffective as the hook fails to properly catch or snag the fish's lip and thereby decreases the chance of catching fish. People may feel helpless in such situations and may not enjoy their fishing trip or fishing experience.

Therefore, there exists a long felt need in the art for an improved jig for luring and catching fish. There is also a long felt need in the art for an improved jig that is effective in catching fish. Additionally, there is a long felt need in the art for an improved jig that enables the bait to mimic live bait while being threaded to the jig structure. Moreover, there is a long felt need in the art for an improved jig that enables the users to properly thread the hook onto certain baits. Further, there is a long felt need in the art for a jig having hooks that resist breaking and enable the users to catch fish even when one of the hooks is broken. Furthermore, there is a long felt need in the art for an improved jig that ensures the jig catches the fish's lips properly and has a higher success rate in catching fish in comparison to standard jigs/hooks. Finally, there is a long felt need in the art for an improved jig that offers a way to catch more fish, and improves the overall enjoyment of a fishing excursion.

The subject matter disclosed and claimed herein, in one embodiment thereof, comprises a double jig hook that is designed as an improved fishing hook or jig with two barbed hooks. The two barbed hooks of the double jig hook improve the success rate of catching fish. The double jig hook comprises a linear shank having a hook end and an opposite end, wherein a pair of barbed U-shaped hooks are extended from the hook end. The barbed hooks can have different shapes and sizes in different embodiments to catch fish. Further, the opposite end of the linear shank includes a jig head to which an eyelet is connected. The eyelet is generally-positioned at ninety degrees to the linear shank, however can meet at different angles such as forty-five degree, thirty degree and more in different embodiments. Furthermore, each hook of the double jig hook includes a barbed end such that the two barbed hooks together can catch the top and bottom parts of a fish's lip to maximize securement and success chance on a catch.

In this manner, the double jig hook of the present invention accomplishes all of the forgoing objectives and provides a jig device that can mimic live bait. The hook device also provides an improved fishing experience as the two hooks together catch a fish efficiently and securely. Barbs on the hooks ensure that the hooks engage the top part and lower part of a fish's mouth to maximize success chances on a catch and offers a way to catch more fish and improve the overall enjoyment of a fishing trip.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a double jig hook. The double jig hook is designed as an improved fishing hook or jig with two barbed hooks. The double jig hook further comprising a linear shank having a hook end and an opposite end, a pair of barbed U-shaped hooks extend from the hook end, wherein a first hook extends upward from the linear shank and a second hook extends downward from the linear shank. The opposite end of the linear shank includes a jig head to which an eyelet or eye is connected. The eyelet or eye can be positioned at an angle, for example ninety degrees, relative to the linear shank and can be proximal to the jig head. Each hook includes a barbed end such that the two barbed hooks, together catch the top and bottom parts of a fish's lip, to maximize securement and success chances on a catch.

In yet another embodiment of the present invention, a fishing hook is disclosed. The fishing hook includes a shank portion and two barbed hooks, wherein the barbed hooks extend from a first end of the shank portion. The second end of the shank portion includes a jig head for attaching a jig and for connecting to an eyelet or eye positioned at, for example, ninety degrees, forty-five degrees, or thirty degrees relative to the shank portion.

In yet another embodiment, the present invention provides a fishing hook made from a single barbed wire. The fishing hook includes two barbed hooks for catching the top and bottom parts of a fish's lip using the barbed ends, a shank portion that includes barbs for additional support in catching the fish wherein the shank portion is formed by bending the single barbed wire from the middle and then forming the hooks by bending the barbed ends of the barbed wire away from each other to form U-shaped hooks.

In yet another embodiment of the present invention, the hooks can be one or more of U-shaped, a partial straight and partial curved shape. Further, both the hooks can be of the same shape or different shapes (i.e. different shank lengths and/or different bends).

In yet another embodiment of the present invention, the double jig hook can be made from two wires, wherein one wire is used for making a first hook and the second wire is used for making a second hook and the wires are intertwined to form the shank portion.

In yet another embodiment, the eyelet or eye is connected to the shank portion and can be positioned at an angle, for example thirty, forty-five, or ninety degrees, relative to the shank using welding or a mechanical fastener.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a first potential embodiment of a double jig hook of the present invention in accordance with the disclosed architecture;

FIG. 2 illustrates a perspective view of a second potential embodiment of the double jig hook of the present invention in accordance with the disclosed architecture;

FIG. 3 illustrates a perspective view showing a road runner bait attached to the jig head of the barbed shank double jig hook of the present invention in accordance with the disclosed architecture;

FIG. 4 illustrates a perspective view showing a barbed shank double jig hook with different-shaped barbed hooks as a third potential embodiment of the double jig hook of the present invention in accordance with the disclosed architecture;

FIG. 5 illustrates a perspective view of a fourth potential embodiment of the double jig hook of the present invention in accordance with the disclosed architecture;

FIG. 6 illustrates a perspective view of a fifth potential embodiment of the double jig hook of the present invention in accordance with the disclosed architecture; and

FIG. 7 illustrates a perspective view showing use of a single wire for making the barbed hooks of the double jig hook of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved jig for luring and catching fish. There is also a long felt need in the art for an improved jig that is effective in catching fish. Additionally, there is a long felt need in the art for an improved jig that enables the bait to mimic live bait, while being threaded to the jig structure. Moreover, there is a long felt need in the art for an improved jig that enables the users to properly thread the hook onto certain baits. Further, there is a long felt need in the art for a jig having hooks that resist breaking and enable the users to catch fish even when one of the hooks is broken. Furthermore, there is a long felt need in the art for an improved jig that ensures the jig catches the fish's lips properly and has a higher success rate in catching fish in comparison to standard jigs/hooks. Finally, there is a long felt need in the art for an improved jig that offers a way to catch more fish and improves the overall enjoyment of a fishing excursion.

The present invention, in one exemplary embodiment, includes a novel fishing hook. The fishing hook includes an eyelet, shank portions, bend portions, and a plurality of barbs at one end, wherein at least one barb extends from a first point and another barb extends from a second point. Further, at another end of the shank portions, the fishing hook includes a jig head for attaching a jig and for connecting to an eyelet or eye. The eye can be positioned relative to the shank portions at one of ninety-degrees, forty-five degrees, or thirty degrees.

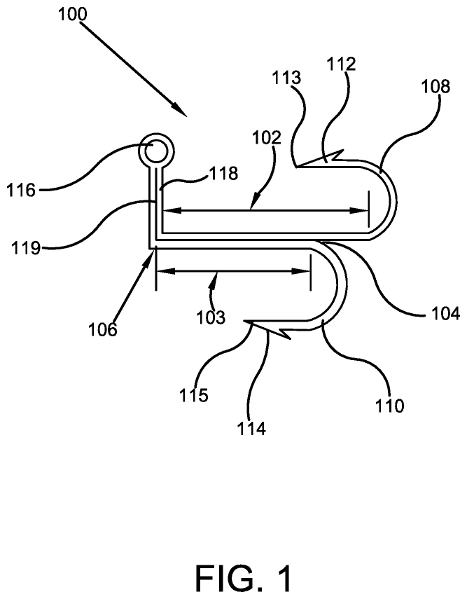

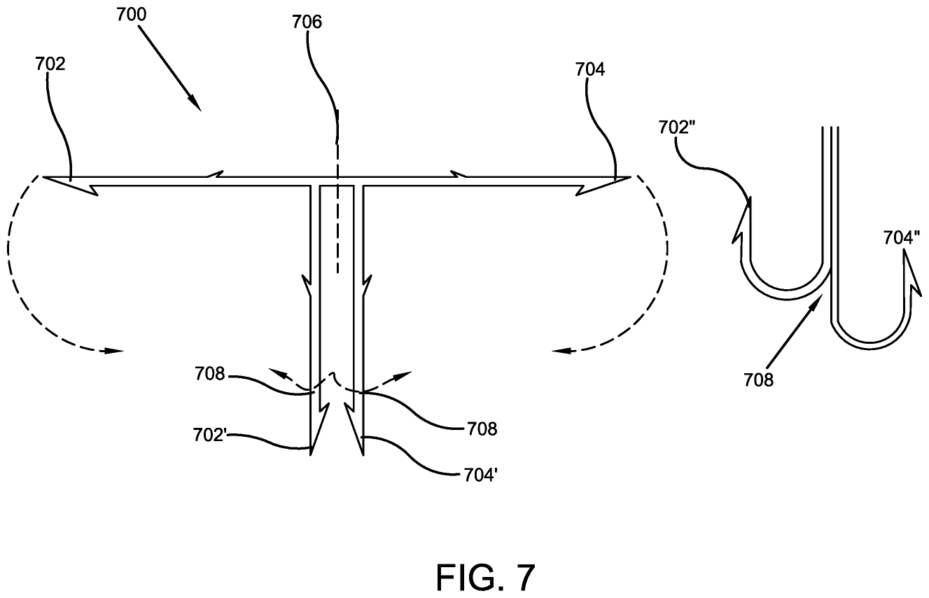

Referring initially to the drawings, FIG. 1 illustrates a perspective view of a first potential embodiment of a double jig hook 100 of the present invention in accordance with the disclosed architecture. The double jig hook 100 of the present embodiment can be made from intertwined wires, connected wires, or from a single wire (as described in FIG. 7). The double jig hook 100, at one hook end 104, includes a first shank portion 102, a first bend 108, a second shank portion 103, and a second bend 110. The hook 100 includes an eyelet end 106. At the hook end 104, a first bend 108 extends in an upward direction and a second bend 110 extends in an opposing downward direction. As shown, the first bend 108 includes a first barb 112 and a first point 113, and the second bend 110 includes a second barb 114 and a second point 115. The bends 108, 110 are designed to catch the top and bottom parts of a fish's lip using the barbs 112, 114, and points 113, 115, respectively, to maximize securement and success rates when hooking fish. Each bend 108, 110 can be made from a separate wire such that the wires are intertwined or connected along the shank portions 102, 103, or from a single barbed wire having barbed ends. The first shank portion 102 can be longer than the second shank portion 103 wherein the first bend 108 extends further than the second bend 110 from the hook end 104. Alternatively, the shank portions 102, 103 can be the same length (not illustrated) whereby the first bend 108 and the second bend 110 include the same extension. The eye or eyelet 116 is located at the eyelet end 106. The eyelet 116 and the shank portions 102, 103 meet perpendicularly at the eyelet end 106 using vertical shank portions 118, 119 positioned perpendicular to the shank portions 102, 103. The shank portions 102, 103 and the vertical shank portions 118, 119 are linear or straight. The eyelet 116 is positioned perpendicular to the lengths of the shank portions 102, 103 and can be used for attaching a stinger hook, flasher, or spoon.

The hook 100 and wires can be made from high-carbon steel. The barbs 112, 114 and points 113, 115 are sharp for catching and locking fish. Further, the jig hook 100 is suitable for both freshwater and saltwater. The barbs 112, 114 are helpful to lock a fish and are useful for bass fishing, largemouth bass, walleye, crappie salmon, trout, panfish carp, and more.

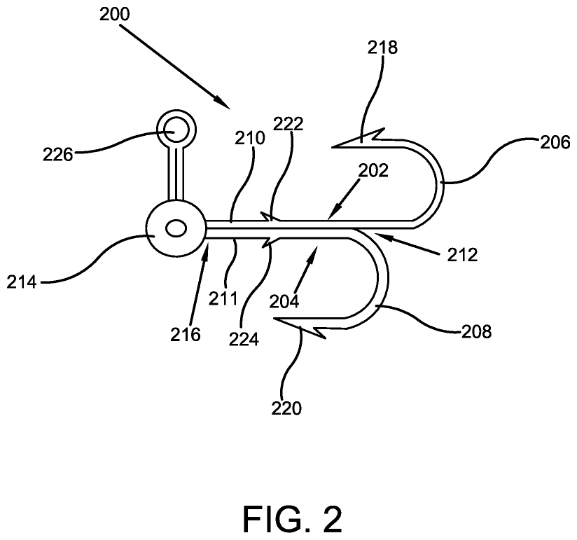

FIG. 2 illustrates a perspective view of a second potential embodiment of the double jig hook of the present invention in accordance with the disclosed architecture. The barbed shank double jig hook 200 of the present embodiment includes two wires 202, 204 used for forming two shank portions 210, 211 and two bend portions 206, 208. The first barbed bend portion 206 and the second barbed bend portion 208 extend in opposing directions from one end 212. A jig head 214 is positioned on another opposing hook end 216. The first barbed bend 206 includes a first barb 218 and the second barbed bend 208 includes a second barb 220 to catch the top and bottom parts of a fish's lip and to maximize securement and success rates when hooking fish. The shank portions 210, 211 include a barbs 222, 224, respectively, at opposing sides for increasing chances of the securement of a fish. An eyelet 226 is positioned in a direction perpendicular to the shank portions 210, 211 wherein the eyelet 226 and the shank portions 210, 211 meet at the jig head 214 such that the eyelet 226 is positioned perpendicular to the length of the shank portions 210, 211 and can be used for attaching a stinger hook, flasher, or spoon thereto.

The jig head 214 can be used for attaching an artificial or natural bait for catching a fish. The barbs 218, 220, 222, 224 of the jig hook 200 are designed to work in coordination to maximize securement and success rates when hooking fish.

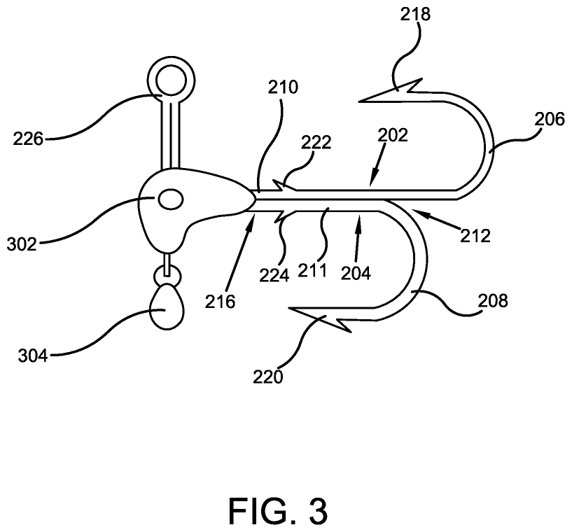

FIG. 3 illustrates a perspective view showing a road runner bait attached to the jig head of the barbed shank double jig hook 200 of the present invention in accordance with the disclosed architecture. The double jig hook of various embodiments of the present invention can be used for attaching any artificial or natural bait to lure fish. As shown here as an example, a road runner bait 302 can be attached to the jig head at the end 216 of the shank portions 210, 211. The bait 302, having a blade 304 connected thereto, can be used for luring fish. The eyelet 226 is positioned in a perpendicular direction relative to the bait 302 and thus improves the efficiency of the fishing process to lure and catch fish. It should be noted that road runner bait 302 can be of any type including, but not limited to, Natural Science Trout and Panfish Road Runner, Curly-Tail Road Runner, Natural Science Road Runner, Original Marabou Road Runner, and others can be used.

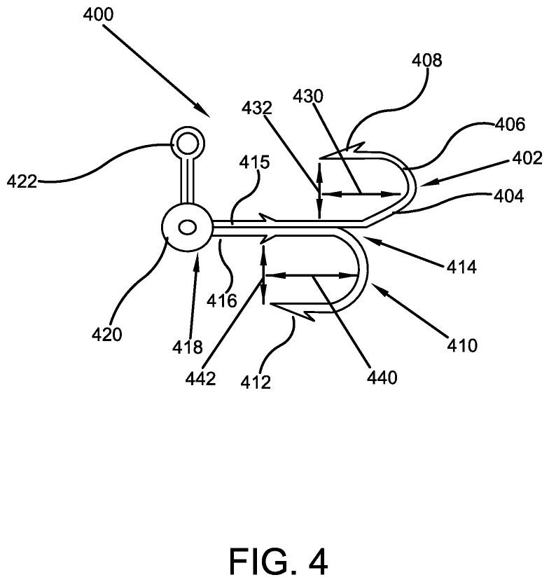

FIG. 4 illustrates a perspective view showing a barbed shank double jig hook with different shaped barbed bends as a third potential embodiment of the double jig hook of the present invention in accordance with the disclosed architecture. In the present embodiment, the barbed double jig hook 400 includes a first barbed bend 402 that includes a partial tapered portion 404 and a partial curved portion 406 wherein the curved portion 406 terminates in a barb 408. A second barbed bend 410 includes a U-shape and has a barbed end 412. The different shapes of the bends 402, 410 enables different types of fish to be caught easily. The bends 402, 410 extend, respectively, from the hook end 414 of the shank portions 415, 416. The first bend 402 includes a first throat 430 and a first gape 432. The second bend 410 includes a second throat 440 and a second gape 442. In one potential embodiment, the first throat 430 can be longer than the second throat 440; and, the first gape 432 can be less than the second gape 442. The other hook end 418 of the shank portions 415, 416 includes a jig head 420 for attaching a bait. The shank portions 415, 416 and the eyelet 422 are connected to each other at the jig head 420 such that the eyelet 422 is positioned at ninety degrees relative to the shank portions 415, 416.

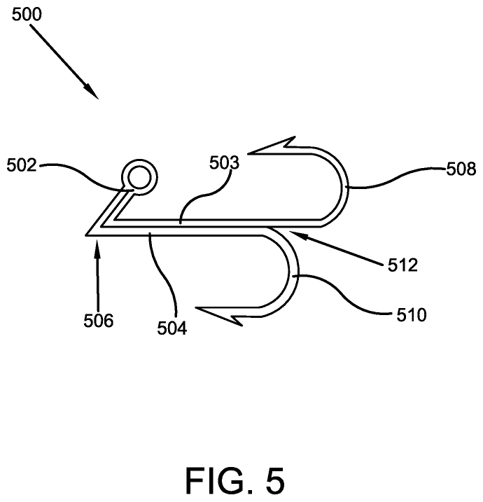

FIG. 5 illustrates a perspective view of a fourth potential embodiment of the double jig hook of the present invention in accordance with the disclosed architecture. In the present embodiment, the double jig hook 500 includes an eyelet 502 positioned at thirty degrees relative to the linear shank portions 503, 504 and meets the shank portions 503, 504 at the hook end 506. The barbed bend portions 508, 510 are extended from the shank portions 503, 504, respectively at a second hook end 512. Each barbed bend 508, 510 can be from a separate wire wherein the wires are intertwined or connected to form the shank portions 503, 504, or can be from a single wire with barbed ends. The eyelet 502 can be positioned in either direction i.e., upward or downward relative to the linear shank portions 503, 504 as per the requirements of a user.

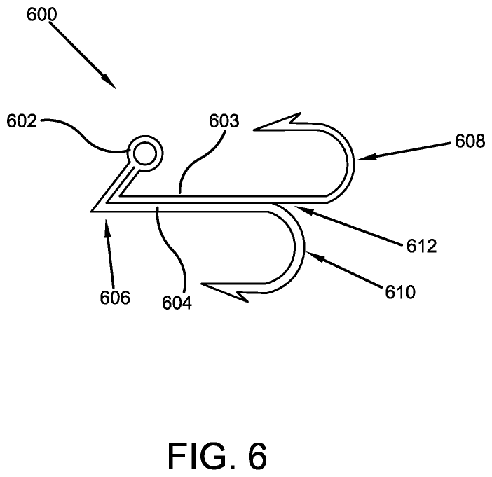

FIG. 6 illustrates a perspective view of a fifth potential embodiment of the double jig hook of the present invention in accordance with the disclosed architecture. In the present embodiment, the double jig hook 600 includes the eyelet 602 positioned at forty-five degrees relative to the linear shank portions 603, 604 and meets the shank portions 603, 604 at the hook end 606. The barbed bends 608, 610 are extended from the linear shank portions 603, 604, respectively, at the second hook end 612. Each barbed bend 608, 610 extends from a separate wire wherein the wires are intertwined to form the shank portions 603, 604, or can be formed from a single wire with barbed ends. The eyelet 602 can be positioned in either direction, i.e., upward or downward, relative to the linear shank portions 603, 604 as per the requirements of a user.

FIG. 7 illustrates a perspective view showing use of a single wire for making the barbed hook shanks and bends of the double jig hook of the present invention in accordance with the disclosed architecture. The double jig hook of various embodiments can be made with two wires that are intertwined to form the shank portions and bend sections, or can be made with a single wire 700 having two barbed ends 702, 704. Initially, the barbed wire 700 is bent through the middle point 706 to meet the barbed ends 702, 704 such that the first barbed end 702 reaches the position 702′ and the second barbed end 704 reaches the second barbed end 704′ with the barbed wire 700 generally bent into two equal portions. It should be noted that the bending can be done at any appropriate length of the barbed wire 700. Then, to form the hooks, at the barbed end position 702′ and 704′, an outward bend is made to form a U-shaped bend such that the barbed end 702′ reaches the final position 702″, and still another outward bend is made to form a U-shaped bend such that the barbed end 704′ reaches the final position 704″ to form the bends along the position 708. In place of a single wire, two wires can be used for making the bends and the wires are intertwined to form the shank portions.

The barbed hooks of various embodiments of double jig hook of the present invention can be placed anywhere on a lure, wire, shaft, line leader or string and are symmetrical in any position on a wire, shaft, line leader or string. The barbed hooks used in the present invention are more humane to fish due to the fact that they allow hooking the fish properly through the mouth. Further, the double jig hook can be used with any type of conventional jigs such as swim jig, football jig, tube jig, hair jig, punch jig, finesse jig and many more.

The unique design of having eyelet at certain angles to the shank portion and a pair of barbed hooks of the present invention can create many new lure-making possibilities and brand new design opportunities for the fishing industry while ensuring that the jig hook engages the top and lower part of a fish's mouth to maximize success chance on a catch. Further, even one hook is broken, the other hook can be used for fishing purpose.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “double jig hook”, “barbed shank double jig hook”, “improved fishing hook”, “fishing hook”, and “hook” are interchangeable and refer to the double jig hook 100,200,400,500,600 of the present invention.

Notwithstanding the forgoing, the double jig hook 100,200,400,500,600 of the present invention can be of any suitable size and configuration as is known in the art without affecting the overall concept of the invention, provided that it accomplishes the above stated objectives. One of ordinary skill in the art will appreciate that the size, configuration, and material of the double jig hook 100,200,400,500,600 as shown in the FIGS. are for illustrative purposes only, and that many other sizes and shapes of the double jig hook 100,200,400,500,600 are well within the scope of the present disclosure. Although the dimensions of the double jig hook 100,200,400,500,600 are important design parameters for user convenience, the double jig hook 100,200,400,500,600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A barbed double jig hook comprising:
an eyelet;
a first shank portion;
a first bend;
a second shank portion, wherein said first shank portion comprises a first barb and said second shank portion comprises a second barb and further wherein said first bend terminates at a third barb;
a second bend, wherein said first bend extends orthogonal to said second bend at a first end of said barbed double jig hook, and further wherein said second bend terminates at a fourth barb; and
a jig head positioned at an opposing end of said barbed double jig hook, wherein said eyelet is positioned in a direction orthogonal to said first and said second shank portions.

2. The barbed double jig hook of claim 1, wherein said first shank portion comprises a first length and said second shank portion comprises a second length, and further wherein said first shank length is greater than said second shank length.

3. The barbed double jig hook of claim 2, wherein said first bend is different from said second bend.

4. The barbed double jig hook of claim 3, wherein said first bend comprises a first gape and said second bend comprises a second gape, and further wherein said first gape is less than said second gape.

5. The barbed double jig hook of claim 4, wherein said first bend comprises a first throat and said second bend comprises a second throat, and further wherein said first throat is greater than said second throat.

6. A barbed double jig hook comprising:
an eyelet;
a first shank portion comprising a first barb and a first length;
a first bend;
a second shank portion comprising a second barb and a second length;
a second bend, wherein said first bend extends orthogonal to said second bend at a first end of said barbed double jig hook; and
a jig head is positioned at an opposing end of said barbed double jig hook, wherein said first bend terminates at a third barb and said second bend terminates at a fourth barb, and further wherein said first shank length is greater than said second shank length.

7. The barbed double jig hook of claim 6, wherein said first bend is different from said second bend.

8. The barbed double jig hook of claim 7, wherein said first bend comprises a first gape and said second bend comprises a second gape, and further wherein said first gape is less than said second gape.

9. The barbed double jig hook of claim 8, wherein said first bend comprises a first throat and said second bend comprises a second throat, and further wherein said first throat is greater than said second throat.

10. The barbed double jig hook of claim 6, wherein said eyelet is positioned in a direction orthogonal to said first and said second shank portions.

11. The barbed double jig hook of claim 6, wherein said eyelet is positioned in a direction generally at thirty degrees relative to said first and said second shank portions.

12. The barbed double jig hook of claim 6, wherein said eyelet is positioned in a direction generally at forty-five degrees relative to said first and said second shank portions.

13. A barbed double jig hook comprising:
an eyelet;
a first shank portion comprising a first length;
a first bend terminating at a first barb;
a second shank portion comprising a second length, wherein said first shank length is greater than said second shank length;
a second bend terminating at a second barb, wherein said first bend extends orthogonal to said second bend at a first end of said barbed double jig hook;
a third shank portion extending orthogonal to said first shank portion; and
a fourth shank portion extending orthogonal to said second shank portion, wherein said eyelet connected to terminal ends of said third shank portion and said fourth shank portion.

14. The barbed double jig hook of claim 13, wherein said first bend is different from said second bend.

15. The barbed double jig hook of claim 13, wherein said first bend comprises a first gape and said second bend comprises a second gape, and further wherein said first gape is less than said second gape.

16. The barbed double jig hook of claim 13, wherein said first bend comprises a first throat and said second bend comprises a second throat, and further wherein said first throat is greater than said second throat.

17. The barbed double jig hook of claim 13, wherein said first shank portion comprises a first shank barb and said second shank portion comprises a second shank barb.

18. The barbed double jig hook of claim 13 further comprising a jig head positioned at another opposing end of said barbed double jig hook.

19. The barbed double jig hook of claim 18 further comprising a blade connected to said jig head.

20. The barbed double jig hook of claim 17, wherein said first bend comprises a first gape and said second bend comprises a second gape and further wherein said first gape is less than said second gape.
